(19) United States
(12) Patent Application Publication
(10) Pub. No.: US 2009/0085240 A1
(43) Pub. Date: Apr. 2, 2009

(54) USE OF AN AQUEOUS POLYMER COMPOSITION AS BINDER FOR FIBROUS OR PARTICULATE SUBSTRATES

(76) Inventors: Oihana Elizalde, Mannheim (ES); Matthias Gerst, Neustadt (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/297,661

(22) PCT Filed: Apr. 5, 2007
(86) PCT No.: PCT/EP2007/053362

§ 371 Date: Oct. 20, 2008

(30) Foreign Application Priority Data
Apr. 21, 2006 (DE) 10 2006 019 184.6

(51) Int. Cl. B29C 67/00; C09D 151/06

(52) U.S. Cl. 264/134; 524/531

(57) ABSTRACT

Use of an aqueous polymer composition as a binder for fibrous and granular substrates

The present invention relates to the use of an aqueous polymer composition as a binder for fibrous or granular substrates, the aqueous polymer composition being obtainable by free radical initiated emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
b) from 0 to 20% by weight of at least one further ethylenically unsaturated monomer which differs from the monomers A1 [monomers A2], incorporated in the form of polymerized units,
   and the monomer mixture M being composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1.

The present invention also relates to a process for producing moldings using fibrous or granular substrates and also to the moldings per se.

The consolidation of fibrous or granular substrates, particularly in sheetlike structures, exemplified by fiber webs, fiberboard or chipboard panels, etc., is frequently accomplished chemically using a polymeric binder. To increase the strength, particularly the wet strength and thermal stability, in many cases binders are used which comprise crosslinkers that give off formaldehyde. As a consequence of this, however, there is a risk of unwanted formaldehyde emission.

To avoid formaldehyde emissions there have already been numerous alternatives proposed to the binders known to date. For instance U.S. Pat. No. 4,076,917 discloses binders which comprise carboxylic acid-containing or carboxylic anhydride-containing polymers and β-hydroxyalkylamide crosslinkers. A disadvantage is the relatively costly and inconvenient preparation of the β-hydroxyalkylamides.

EP-A 445 578 discloses boards made of finely divided materials, such as glass fibers, for example, in which mixtures of high molecular weight polycarboxylic acids and polyhydric alcohols, alkanolamines or polyfunctional amines act as binders. The water resistance of the boards obtained, however, is unsatisfactory.

EP-A 583 086 disposes formaldehyde-free aqueous binders for producing fiber webs, especially glass fiber webs. The binders comprise a polycarboxylic acid having at least two carboxylic acid groups and also, if appropriate, anhydride groups, and a polyol. These binders require a phosphorus reaction accelerant in order to achieve sufficient strengths in the glass fiber webs. It is noted that the presence of such a reaction accelerant is vital unless a highly reactive polyol is used. Highly reactive polyols specified include β-hydroxyalkylamides.

EP-A 651 088 describes corresponding binders for substrates made from cellulosic fiber. These binders necessarily comprise a phosphorus reaction accelerant.

EP-A 672 920 describes formaldehyde-free binding, impregnating or coating compositions which comprise at least one polyol and a polymer which is composed to an extent of from 2 to 100% by weight of an ethylenically unsaturated acid or acid anhydride comonomer. The polyols in question are substituted triazine, triazine trione, benzene or cyclohexyl derivatives, and the polyol radicals are always located in positions 1, 3, and 5 of the aforementioned rings. In spite of a high drying temperature the wet tensile strengths achieved with these binders on glass fiber webs are low.

DE-A 22 14 450 describes a copolymer composed of from 80 to 99% by weight of ethylene and from 1 to 20% by weight of maleic anhydride. Together with a crosslinking agent, the copolymer is used in powder form or in dispersion in an aqueous medium for the purpose of surface coating. The crosslinking agent used is a polyalcohol which contains amino groups. In order to bring about crosslinking, however, heating must be carried out at up to 300° C.

EP-A 257 567 describes a polymer composition obtainable by emulsion polymerization of ethylenically unsaturated monomers, such as olefins, vinylaromatic compounds, α,β-ethylenically unsaturated carboxylic acids and their esters, ethylenically unsaturated dicarboxylic anhydrides, and vinyl halides. In the course of the polymerization a resin which is dispersible or soluble in alkali or water and has a number average molecular weight of approximately 500 to approximately 20 000 is added in order to influence the flow properties of the polymer composition. The resin is synthesized from olefins, vinylaromatic compounds, α,β-ethylenically unsaturated carboxylic acids and the esters thereof or ethylenically unsaturated dicarboxylic anhydrides. The composition can be used to produce formaldehyde-free coatings on wood substrates.

EP-A 576 128 describes repulpable adhesive compositions which comprise an acid-rich polymer component and an acid-poor polymer component. The acid-poor polymer component is based on a monomeric mixture of from 40 to 95% of an alkyl acrylate or methacrylate and from 5 to 60% of an ethylenically unsaturated acid, such as acrylic acid or methacrylic acid. The acid-poor polymer component is based on a monomer mixture of from 90 to 100% of an alkyl acrylate or alkyl methacrylate and from 0 to 10% of an ethylenically unsaturated acid. The composition is prepared by aqueous emulsion polymerization, the acid-rich polymer component being polymerized in the presence of the acid-poor polymer component or vice versa. The pH of the composition is adjusted to the desired level by adding ammonium hydroxide or sodium hydroxide. The composition can be used as a pressure-sensitive adhesive, laminating adhesive, adhesive for textiles, tiles, and packaging, and as wood glue.

U.S. Pat. No. 5,314,943 describes a rapid-cure low-viscosity formaldehyde-free binder composition for textile materials. The composition comprises a latex, which is a copolymer based on a vinylaromatic compound and a conjugated diene, and a water-soluble copolymer, which is obtained by copolymerizing a mixture of at least one ethylenically unsaturated polycarboxylic acid and at least one olefinically unsaturated monocarboxylic acid.

U.S. Pat. No. 4,868,016 describes a composition based on at least one thermoplastic latex polymer which is insoluble in an aqueous alkaline medium and on at least one alkali-soluble polymer which is not compatible with the latex polymer. The latex polymer is an aqueous dispersion of a polymer which may be composed of acrylic or methacrylic esters, vinylaromatic compounds, and vinyl esters and which additionally comprises from 0.5 to 3% by weight of an ethylenically unsaturated carboxylic acid in the form of polymerized units. The alkali-soluble polymer as well is constructed from the aforementioned monomers but comprises from 10 to 60% by weight of an ethylenically unsaturated carboxylic acid. It can be used for the purpose of providing substrates with a coating.

It is known that stable aqueous (meth)acrylate dispersions are obtained by emulsion polymerization in the presence of protective colloids only when at least 50% of vinyl acetate, based on total monomers, is incorporated in the form of polymerized units. With less than 50% of vinyl acetate, agglomeration takes place. U.S. Pat. No. 4,670,505 describes solving this problem by means of a polyacrylate dispersion which is prepared by emulsion polymerization in the presence of from 0.1 to 5% by weight of at least one water-soluble amino alcohol having from 2 to 36 carbon atoms and from 0.04 to 5% by weight of a protective colloid, based in each case on total monomers.

EP-A 537 910 discloses mixtures of emulsion polymers constructed preferably from styrene and n-butyl acrylate with acid-rich water-soluble polymers, which when used as binders for paints are said to give coatings having effective substrate wetting and high solvent resistance.

U.S. Pat. No. 5,143,582 discloses the production of heat-resistant nonwoven materials using a thermosetting heat-resistant binder. The binder is formaldehyde-free and is obtained by mixing a crosslinker with a polymer containing carboxylic acid groups, carboxylic anhydride groups or carboxylic salt groups. The crosslinker is a β-hydroxyalkylamide or a polymer or copolymer thereof. The polymer crosslinkable with the β-hydroxyalkyl-amide is synthesized from unsaturated monocarboxylic or dicarboxylic acids, salts of unsaturated monocarboxylic or dicarboxylic acids, or unsaturated anhydrides, for example. Self-curing polymers are obtained by copolymerizing the β-hydroxyalkyl-amides with monomers comprising carboxyl groups.

DE-A 197 29 161 describes thermally curable aqueous polymer dispersions (polymer 1) prepared in the presence of a carboxyl-containing polymer (polymer 2) and a surface-active amine. In addition the dispersions may optionally further comprise an alkanolamine having at least two hydroxyl groups. Preparing a polymer dispersion on the basis of a polymer 1 by carrying out polymerization in the presence of a polymer 2 which comprises in incorporated form a reaction product of an ethylenically unsaturated carboxylic anhydride and at least one alkoxylated alkylamine is not described in this document. When the compositions of DE-A-1 97 29 161 are used as a thermally curable binder for fibrous and granular substrates, their combination of low viscosity with high solids content is advantageous. Shaped parts which enjoy high mechanical strength are obtained, but their dimensional stability under humid conditions is deserving of improvement. Moreover, the colloidal stability of these polymer dispersions is very low: dilution with water is frequently enough to lead to observed agglomeration and/or coagulation.

German patent application DE-A 199 00 459 discloses a similar polymer dispersion, but where the dispersed polymer particles possess a relatively high α,β-ethylenically unsaturated carboxylic acid content.

German patent application DE-A 199 00 460 discloses a polymer dispersion comprising i) polymer particles which are dispersed in an aqueous medium and are composed of units of ethylenically unsaturated monomers, ii) a water-soluble polymeric polyelectrolyte which along a polymeric backbone carries a multiplicity of ionic groups of uniform charge character or groups which can be ionized to such, and iii) an ionic surfactant which carries an ionic group having a charge character opposite to that of the polymeric polyelectrolyte, or a group which can be ionized to such. The polyelectrolyte is preferably composed of units of ethylenically unsaturated monomers, examples being ethylenically unsaturated monocarboxylic or dicarboxylic acids and units of N-substituted amides of such acids, there being no alkoxylated amides disclosed. The polymer dispersion can be coagulated by simple dilution with water.

The unpublished German patent application with the file reference DE 10 2006 001 979.2 discloses the use of an aqueous polymer composition comprising a polyacid and an epoxy-functionalized or hydroxyalkyl-functionalized polymer for the purpose of impregnating base paper. No use is found of the aqueous polymer composition for other applications, however.

It was an object of the present invention to provide an alternative formaldehyde-free binder system for fibrous or granular substrates.

Accordingly, the use defined at the outset was found.

According to the invention, an aqueous polymer composition is used which is obtainable by free radical initiated emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
b) from 0 to 20% by weight of at least one further ethylenically unsaturated monomer which differs from the monomers A1 [monomers A2], incorporated in the form of polymerized units,
   and the monomer mixture M being composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1.

The procedure for free radical initiated emulsion polymerizations of ethylenically unsaturated monomers in an aqueous medium has been widely described in the past and is therefore sufficiently well known to the person skilled in the art [cf. in this context emulsion polymerization in Encyclopedia of Polymer Science and Engineering, Vol. 8, page 659 et seq. (1987); D. C. Blackley, in High Polymer Latices, Vol. 1, page 35 et seq. (1966); H. Warson, The Applications of Synthetic Resin Emulsions, Chapter 5, page 246 et seq. (1972); D. Diederich, Chemie in unserer Zeit 24, pages 135 to 142 (1990); Emulsion Polymerisation, Interscience Publishers, New York (1965); DE-A 40 03 422 and Dispersionen synthetischer Hochpolymerer, F. Hölscher, Springer-Verlag, Berlin (1969)]. The free radical initiated aqueous emulsion polymerization reactions are usually effected in such a way that the ethylenically unsaturated monomers are dispersed with the concomitant use of dispersants in an aqueous medium and in the form of monomer droplets and are polymerized by means of a free radical polymerization initiator. The preparation of the aqueous polymer composition present according to the invention differs from the known prior art in that a specific monomer mixture M is subjected to free radical polymerization in the presence of a specific polymer A.

The aqueous polymer composition is prepared using water, preferably drinking water, and with particular preference deionized water, the total amount thereof being calculated such that it amounts to 30 to 90% by weight and advantageously 40 to 60% by weight, based in each case on the aqueous polymer composition.

According to the invention, a polymer A is used which is composed of
a) from 80 to 100% by weight of at least one ethylenically unsaturated mono- and/or dicarboxylic acid [monomers A1] and
b) from 0 to 20% by weight of at least one further ethylenically unsaturated monomer which differs from the monomers A1 [monomers A2], incorporated in the form of polymerized units.

Suitable monomers A1 are in particular α,β-monoethylenically unsaturated mono- and dicarboxylic acids which have 3 to 6 carbon atoms, possible anhydrides thereof and water-soluble salts thereof, in particular alkali metal salts thereof, such as, for example, acrylic acid, methacrylic acid, maleic acid, fumaric acid, itaconic acid, citraconic acid, tetrahydrophthalic acid and the anhydrides thereof, such as, for example, maleic anhydride, and the sodium or potassium salts of the abovementioned acids. Acrylic acid, methacrylic acid and/or maleic anhydride are particularly preferred, acrylic acid being especially preferred.

For the preparation of the polymer A used according to the invention, in particular ethylenically unsaturated compounds which can be subjected to free radical copolymerization with monomer A1 in a simple manner are suitable as at least one monomer A2, such as, for example, ethylene, vinyl aromatic monomers, such as styrene, α-methyl styrene, o-chlorostyrene or vinyltoluenes, vinyl halides, such as vinyl chloride or vinylidene chloride, esters of vinyl alcohol and monocarboxylic acids having 1 to 18 carbon atoms, such as vinyl acetate, vinyl propionate, vinyl n-butyrate, vinyl laurate and vinyl stearate, esters of α,β-monoethylenically unsaturated mono- and dicarboxylic acids having preferably 3 to 6 carbon atoms, such as, in particular, acrylic acid, methacrylic acid, maleic acid, fumaric acid and itaconic acid, with alkanols having in general 1 to 12, preferably 1 to 8 and in particular 1 to 4 carbon atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate, nitriles of α,β-monoethylenically unsaturated carboxylic acids, such as acrylonitrile, methacrylonitrile, fumarodinitrile, maleodinitrile, and C₄₋₈-conjugated dienes, such as 1,3-butadiene (butadiene) and isoprene. Said monomers are as a rule the main monomers which, based on the total amount of monomers A2, together account for a proportion of ≧50% by weight, preferably ≧80% by weight and particularly preferably ≧90% by weight or even constitute the total amount of the monomers A2. As a rule, these monomers have only a moderate to low solubility in water under standard temperature and pressure conditions [20° C., 1 atm (absolute)].

Monomers A2 which have a high water solubility under the abovementioned conditions are those which comprise either at least one sulfonic acid group and/or the corresponding anion thereof or at least one amino, amido, ureido or N-heterocyclic group and/or the ammonium derivatives thereof which are alkylated or protonated on the nitrogen. Acrylamide and methacrylamide and furthermore vinylsulfonic acid, 2-acrylamido-2-methylpropanesulfonic acid, styrenesulfonic acid and the water-soluble salts thereof and N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolin-2-onyl)ethyl methacrylate may be mentioned by way of example. Usually, the abovementioned water-soluble monomers A2 are present only as modifying monomers in amounts of ≦10% by weight, preferably ≦5% by weight and particularly preferably ≦3% by weight, based on the total amount of monomers A2.

Monomers A2, which usually increase the internal strength of the films of a polymer matrix, usually have at least one epoxy, hydroxyl, N-methylol or carbonyl group or at least two nonconjugated ethylenically unsaturated double bonds. Examples of these are monomers having two vinyl radicals, monomers having two vinylidene radicals and monomers having two alkenyl radicals. Particularly advantageous are the diesters of dihydric alcohols with α,β-monoethylenically unsaturated monocarboxylic acids, among which acrylic and methacrylic acid are preferred. Examples of such monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and divinyl benzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Also of particular importance in this context are C₁-C₈-hydroxyalkyl methacrylates and acrylates, such as n-hydroxyethyl, n-hydroxypropyl or n-hydroxybutyl acrylate and methacrylate, and compounds such as diacetoneacrylamide and acetylacetoxyethyl acrylate or methacrylate. Frequently, the abovementioned crosslinking monomers A2 are used in amounts of ≦10% by weight, but preferably in amounts of ≦5% by weight, based in each case on the total amount of monomers A2. Particularly preferably however, no such crosslinking monomers A2 at all are used for the preparation of the polymer A.

Advantageously, monomer mixtures which comprise

| | |
|---|---|
| from 50 to 100% by weight | of esters of acrylic and/or methacrylic acid |
| | with alkanols having 1 to 12 carbon |
| | atoms, or |
| from 50 to 100% by weight | of styrene and/or butadiene, or |
| from 50 to 100% by weight | of vinyl chloride and/or vinylidene chloride, |
| | or |
| from 40 to 100% by weight | of vinyl acetate, vinyl propionate and/or |
| | ethylene |

are used as monomers A2 for the preparation of the polymer A.

According to the invention, the polymerized proportion of monomers A2 in the polymer A is advantageously ≦10% by weight or ≦5% by weight. Particularly advantageously, the polymer A comprises no monomers A2 at all incorporated in the form of polymerized units.

The preparation of polymers A is familiar to the person skilled in the art and is effected in particular by free radical initiated solution polymerization, for example in water or in an organic solvent (see for example A. Echte, Handbuch der Technischen Polymerchemie, chapter 6, VCH, Weinheim, 1993 or B. Vollmert, Grundriss der Makromolekularen Chemie, volume 1, E. Vollmert Verlag, Karlsruhe, 1988).

Polymer A advantageously has a weight average molecular weight of ≧1000 g/mol and ≦100 000 g/mol. It is advantageous if the weight average molecular weight of polymer A is ≦50 000 g/mol or ≦30 000 g/mol. Particularly advantageously, polymer A has a weight average molecular weight of ≧3000 g/mol and ≦20 000 g/mol. Establishing the weight average molecular weight during the preparation of polymer A is familiar to the person skilled in the art and is advantageously effected by free radical initiated aqueous solution polymerization in the presence of free radical chain-transfer compounds, the so-called free radical chain-transfer agents. The determination of the weight average molecular weight is also familiar to the person skilled in the art and is effected, for example, by means of gel permeation chromatography.

According to the invention, it is possible in the preparation of the aqueous polymer composition, if appropriate, initially to take a portion or the total amount of polymer A in the polymerization vessel. However, it is also possible to meter in the total amount or any remaining residual amount of polymer A during the polymerization reaction. The total amount or any remaining residual amount of polymer A can be metered into the polymerization vessel batchwise in one or more portions or continuously with constant or variable flow rates. Particularly advantageously, at least one portion of polymer A is initially taken before initiating the polymerization reaction in the polymerization vessel.

For the preparation of the aqueous polymer composition, it is unimportant whether polymer A is prepared in situ before the polymerization of the monomer mixture M in the polymerization vessel or is used directly as a commercially available or separately prepared polymer.

In the process according to the invention for the preparation of the aqueous polymer composition, dispersants which keep both the monomer droplets and the polymer particles obtained by the free radical initiated polymerization dispersed in the aqueous phase and thus ensure the stability of the aqueous polymer composition produced are frequently concomitantly used. Both the protective colloids usually used for carrying out aqueous free radical emulsion polymerizations and emulsifiers are suitable as such.

Suitable protective colloids are, for example, polyvinyl alcohols, cellulose derivatives or copolymers comprising vinylpyrrolidone. A detailed description of further suitable protective colloids is to be found in Houben-Weyl, Methoden der organischen Chemie, volume XIV/1, Makromolekulare Stoffe, pages 411 to 420, Georg-Thieme-Verlag, Stuttgart, 1961. Since the polymer A used according to the invention can also act as a protective colloid, advantageously no additional protective colloids are used according to the invention.

Of course, mixtures of emulsifiers and/or protective colloids may also be used. Frequently, exclusively emulsifiers whose relative molecular weight, in contrast to the protective colloids, is usually below 1000 are used as dispersants. They may be either anionic, cationic or nonionic. Of course in the case of the use of mixtures of surface-active substances, the individual components must be compatible with one another, which in case of doubt can be checked by means of a few preliminary experiments. In general, anionic emulsifiers are compatible with one another and with nonionic emulsifiers. The same also applies to cationic emulsifiers, whereas anionic and cationic emulsifiers are generally not compatible with one another.

Customary emulsifiers are, for example, ethoxylated mono-, di- and trialkylphenols (degree of ethoxylation: 3 to 50, alkyl radical: C₄ to C₁₂), ethoxylated fatty alcohols (degree of ethoxylation: 3 to 50; alkyl radical: C₈ to C₃₆) and alkali metal and ammonium salts of alkyl sulfates (alkyl radical: C₈ to C₁₂), or sulfuric monoesters of ethoxylated alkanols (degree of ethoxylation: 3 to 30, alkyl radical: C₁₂ to C₁₈) and ethoxylated alkylphenols (degree of ethoxylation: 3 to 50, alkyl radical: C₄ to C₁₂), of alkylsulfonic acids (alkyl radical: C₁₂ to C₁₈) and of alkylarylsulfonic acids (alkyl radical: C₉ to C₁₈). Further suitable emulsifiers are to be found in Houben-Weyl, Methoden der organischen Chemie, volume XIV/1, Makromolekulare Stoffe, pages 192 to 208, Georg-Thieme-Verlag, Stuttgart, 1961.

Compounds of the general formula I

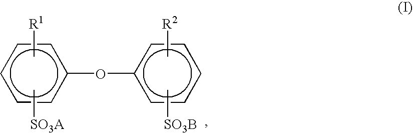

where R¹ and R² are C₄- to C₂₄-alkyl and one of the radicals R¹ or R² may also be hydrogen, and A and B may be alkali metal ions and/or ammonium ions, have furthermore proven suitable as surface-active substances. In the general formula I, R¹ and R² are preferably linear or branched alkyl radicals having 6 to 18 carbon atoms, in particular having 6, 12 or 16 carbon atoms, or H atoms, R¹ and R² not both simultaneously being H atoms. A and B are preferably sodium, potassium or ammonium ions, sodium ions being particularly preferred. Compounds I in which A and B are sodium ions, R¹ is a branched alkyl radical having 12 carbon atoms and R² is an H atom or R¹ are particularly advantageous. Industrial mixtures which have a proportion of from 50 to 90% by weight of the monoalkylated product are frequently used, for example Dowfax® 2A1 (brand of Dow Chemical Company). The compounds I are generally known, for example from U.S. Pat. No. 4,269,749, and are commercially available.

Nonionic and/or anionic emulsifiers are preferably used for the process according to the invention.

As a rule, the amount of additionally used dispersant, in particular emulsifiers, is from 0.1 to 5% by weight, preferably from 1 to 3% by weight, based in each case on the total amount of the monomer mixture M.

According to the invention, it is possible initially to take, if appropriate, a portion or the total amount of dispersant in the polymerization vessel. However, it is also possible to meter in the total amount or any remaining residual amount of dispersant during the polymerization reaction. The total amount or any remaining residual amount of dispersant can be metered into the polymerization vessel batchwise in one or more portions or continuously with constant or variable flow rates. Particularly advantageously, the metering of the dispersants during the polymerization reaction is effected continuously with constant flow rates, in particular as a constituent of an aqueous monomer emulsion.

The monomer mixture M used according to the invention is composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1.

Particularly suitable monomers M1 are glycidyl acrylate and/or glycidyl methacrylate and hydroxyalkyl acrylates and methacrylates having C2- to C10-hydroxyalkyl groups, in particular C2- to C4-hydroxyalkyl groups and preferably C2- and C3-hydroxyalkyl groups. 2-Hydroxyethyl acrylate, 2-hydroxyethyl methacrylate, 3-hydroxypropyl acrylate, 3-hydroxypropyl methacrylate, 4-hydroxybutyl acrylate and/or 4-hydroxybutyl methacrylate may be mentioned by way of example. Particularly advantageously, however, glycidyl acrylate and/or glycidyl methacrylate is used as monomer M1, glycidyl methacrylate being particularly preferred.

According to the invention, it is possible, if appropriate, initially to take a portion or the total amount of monomers M1 in the polymerization vessel. However, it is also possible to meter in the total amount or any remaining residual amount of monomers M1 during the polymerization reaction. The total amount or any remaining residual amount of monomers M1 can be metered into the polymerization vessel batchwise in one or more portions or continuously with constant or variable flow rates. Particularly advantageously, the metering of the monomers M1 during the polymerization reaction is effected continuously with constant flow rates, in particular as a constituent of an aqueous monomer emulsion.

In particular, ethylenically unsaturated compounds which can be subjected to free radical copolymerization in a simple manner with monomer M1, such as, for example, ethylene, vinyl aromatic monomers, such as styrene, α-methylstyrene, o-chlorostyrene or vinyltoluenes, vinyl halides, such as vinyl chloride or vinylidene chloride, esters of vinyl alcohol and monocarboxylic acids having 1 to 18 carbon atoms, such as vinyl acetate, vinyl propionate, vinyl n-butyrate, vinyl laurate and vinyl stearate, esters of α,β-monoethylenically unsaturated mono- and dicarboxylic acids having preferably 3 to 6 carbon atoms, such as, in particular, acrylic acid, methacrylic acid, maleic acid, fumaric acid and itaconic acid, with alkanols having in general 1 to 12, preferably 1 to 8 and in particular 1 to 4 carbon atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate, nitriles of α,β-mono-ethylenically unsaturated carboxylic acids, such as acrylonitrile, methacrylonitrile, fumarodinitrile, maleodinitrile, and C₄₋₈-conjugated dienes, such as 1,3-butadiene (butadiene) and isoprene, are suitable as at least one monomer M2 for the preparation of the aqueous polymer compositions according to the invention. Said monomers are as a rule the main monomers which, based on the total amount of monomers M2, together account for a proportion of ≧50% by weight, preferably ≧80% by weight and particularly ≧90% by weight. As a rule, these monomers have only a moderate to low solubility in water under standard temperature and pressure conditions [20° C., 1 atm (absolute)].

Monomers M2 which have a high water solubility under the abovementioned conditions are those which comprise either at least one acid group and/or the corresponding anion thereof or at least one amino, amido, ureido or n-heterocyclic group and/or the ammonium derivatives thereof which are alkylated or protonated on the nitrogen. α,β-monoethylenically unsaturated mono- and dicarboxylic acids having 3 to 6 carbon atoms and the amides thereof, such as, for example, acrylic acid, methacrylic acid, maleic acid, fumaric acid, itaconic acid, acrylamide and methacrylamide, and furthermore vinylsulfonic acid, 2-acrylamido-2-methylpropanesulfonic acid, styrenesulfonic acid and the water-soluble salts thereof and N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolin-2-onyl)ethyl methacrylate may be mentioned by way of example. Usually, the abovementioned water-soluble monomers M2 are present only as modifying monomers in amounts of ≦10% by weight, preferably ≦5% by weight and particularly preferably ≦3% by weight, based on the total amount of monomers M2.

Monomers M2, which usually increase the internal strength of the films of a polymer matrix, usually have at least one N-methylol or carbonyl group or at least two nonconjugated ethylenically unsaturated double bonds. Examples of these are monomers having two vinyl radicals, monomers having two vinylidene radicals and monomers having two alkenyl radicals. The diesters of dihydric alcohols with α,β-monoethylenically unsaturated monocarboxylic acids are particularly advantageous, and among these acrylic and methacrylic acid are preferred. Examples of such monomers having two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate, and divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. In this context compounds such as diacetoneacrylamide and acetylacetoxyethyl acrylate or methacrylate are also of importance. Frequently, the abovementioned crosslinking monomers M2 are used in amounts of ≦10% by weight, preferably in amounts of ≦5% by weight and particularly preferably in amounts of ≦3% by weight, based in each case on the total amount of monomers A2. Frequently, however, no such crosslinking monomers M2 at all are used.

According to the invention those monomer mixtures which comprise

| | |
|---|---|
| from 50 to 99.9% by weight | of esters of acrylic and/or methacrylic acid |
| | with alkanols having 1 to 12 carbon |
| | atoms, or |
| from 50 to 99.9% by weight | of styrene and/or butadiene, or |
| from 50 to 99.9% by weight | of vinyl chloride and/or vinylidene |
| | chloride, or |
| from 40 to 99.9% by weight | of vinyl acetate, vinyl propionate |
| | and/or ethylene |

are advantageously used as monomers M2.

According to the invention, those monomer mixtures which comprise

| | |
|---|---|
| from 0.1 to 5% | of at least one α,β-monoethylenically unsaturated |
| by weight | mono- and/or dicarboxylic acid having 3 to 6 carbon |
| | atoms and/or the amide thereof and |
| from 50 to 99.9% | of at least one ester of acrylic and/or methacrylic |
| by weight | acid with alkanols having 1 to 12 carbon atoms, or |
| from 0.1 to 5% by | of at least one α,β-monoethylenically unsaturated |
| weight | mono- and/or dicarboxylic acid having 3 to 6 carbon |
| | atoms and/or the amide thereof and |
| from 50 to 99.9% | of styrene and/or butadiene, or |
| by weight | |
| from 0.1 to 5% | of at least one α,β-monoethylenically unsaturated |
| by weight | mono- and/or dicarboxylic acid having 3 to 6 carbon |
| | atoms and/or the amide thereof and |
| from 50 to 99.9% | of vinyl chloride and/or vinylidene chloride, or |
| by weight | |
| from 0.1 to 5% | of at least one α,β-monoethylenically unsaturated |
| by weight | mono- and/or dicarboxylic acid having 3 to 6 carbon |
| | atoms and/or the amide thereof and |
| from 40 to 99.9% | of vinyl acetate, vinyl propionate and/or ethylene |
| by weight | |

are particularly advantageously used as monomers M2.

According to the invention, it is possible, if appropriate, initially to take a portion or the total amount of monomers M2 in the polymerization vessel. However, it is also possible to meter in the total amount or any remaining residual amount of monomers M2 during the polymerization reaction. The total amount or any remaining residual amount of monomers M2 can be metered into the polymerization vessel batchwise in one or more portions or continuously with constant or variable flow rates. Particularly advantageously the metering of the monomers M2 during the polymerization reaction is effected continuously with constant flow rates, in particular as a constituent of an aqueous monomer emulsion.

Advantageously, the monomers M1 and M2 are used together as monomer mixture M in the form of an aqueous monomer emulsion.

According to the invention, advantageously used monomer mixtures M are those whose total content of monomers M1 is from 0.1% by weight to 5% by weight and in particular from 0.5% by weight to 3% by weight, and accordingly the total amount of monomers M2 is from 95% by weight to 99.9% by weight and in particular from 97% by weight to 99.5% by weight.

The free radical initiated polymerization reaction is initiated by means of a free radical polymerization initiator familiar to the person skilled in the art for the aqueous emulsion polymerization (free radical initiator). Said initiators can in principle be both peroxides and azo compounds. Of course, redox initiator systems are also suitable. Peroxides which may be used are in principle inorganic peroxides, such as hydrogen peroxide, or peroxodisulfates, such as the mono- or di-alkali metal or ammonium salts of peroxodisulfuric acid, such as, for example, the mono- and disodium, mono- and dipotassium or ammonium salts thereof, or organic peroxides, such as alkyl hydroperoxides, for example tert-butyl, p-menthyl or cumyl hydroperoxide, and dialkyl or diaryl peroxides, such as di-tert-butyl or di-cumyl peroxide. 2,2′-Azobis(isobutyronitrile), 2,2′-azobis(2,4-dimethylvaleronitrile) and 2,2′-azobis(amidinopropyl)dihydrochloride (AIBA, corresponds to V-50 from Wako Chemicals) are substantially used as the azo compound. Suitable oxidizing agents for redox initiator systems are substantially the abovementioned peroxides. Sulfur compounds having a low oxidation state, such as alkali metal sulfites, for example potassium and/or sodium sulfite, alkali metal hydrogen sulfites for example potassium and/or sodium hydrogen sulfite, alkali metal metabisulfites, for example potassium and/or sodium metabisulfite, formaldehyde sulfoxylates, for example potassium and/or sodium formaldehyde sulfoxylate, alkali metal salts, especially potassium and/or sodium salts, of aliphatic sulfinic acids, and alkali metal hydrogen sulfides, such as, for example, potassium and/or sodium hydrogen sulfide, salts of polyvalent metals, such as iron(II) sulfate, iron(II) ammonium sulfate or iron(II) phosphate, enediols, such as dihydroxymaleic acid, benzoin and/or ascorbic acid, and reducing saccharides, such as sorbose, glucose, fructose and/or dihydroxyacetone, can be used as corresponding reducing agents. As a rule, the amount of the free radical initiator used, based on the total amount of monomer mixture M, is from 0.01 to 5% by weight, preferably from 0.1 to 3% by weight and particularly preferably from 0.2 to 1.5% by weight.

According to the invention, it is possible, if appropriate, initially to take a portion or the total amount of free radical initiator in the polymerization vessel. However, it is also possible to meter in the total amount or any remaining residual amount of free radical initiator during the polymerization reaction. The total amount or any remaining residual amount of free radical initiator can be metered into the polymerization vessel batchwise in one or more portions or continuously with constant or variable flow rates. Particularly advantageously, the metering of the free radical initiator during the polymerization reaction is effected continuously with constant flow rate—in particular in the form of an aqueous solution of the free radical initiator.

The polymerization reaction is effected under temperature and pressure conditions under which the free radical initiated aqueous emulsion polymerization takes place at a sufficient polymerization rate; it is dependent in particular on the free radical initiator used. Advantageously, the type and amount of the free radical initiator, polymerization temperature and polymerization pressure are selected so that the free radical initiator has a half life of ≦3 hours, particularly advantageously ≦1 hour and very particularly advantageously ≦30 minutes.

Depending on the free radical initiator chosen, the total range of from 0 to 170° C. is suitable as a reaction temperature for the free radical initiated polymerization reaction according to the invention of the monomer mixture M. As a rule, temperatures of from 50 to 120° C., in particular from 60 to 110° C. and advantageously from 70 to 100° C. are used. The free radical initiated polymerization reaction according to the invention can be carried out at a pressure of less than, equal to or greater than 1 atm (1.01 bar absolute), so that the polymerization temperature may exceed 100° C. and may be up to 170° C. Preferably readily volatile monomers such as, for example, ethylene, butadiene or vinyl chloride are polymerized under superatmospheric pressure. The pressure may be 1.2, 1.5, 2, 5, 10 or 15 bar (absolute) or may assume even higher values. If polymerization reactions are carried out under reduced pressure, pressures of 950 mbar, frequently 900 mbar and often of 850 mbar (absolute) are established. Advantageously, the free radical initiated polymerization according to the invention is carried out at 1 atm (absolute) under an inert gas atmosphere, such as, for example, under nitrogen or argon.

As a rule, the process according to the invention is advantageously effected in a manner such that at least a portion of the demineralized water used and, if appropriate, a portion of the free radical initiator and of the monomer mixture M and the total amount of the polymer A are initially taken in a polymerization vessel at from 20 to 25° C. (room temperature) and atmospheric pressure under an inert gas atmosphere, the initially taken mixture is then heated to the suitable polymerization temperature with stirring, and any remaining residual amount or the total amount of free radical initiator and monomer mixture M is then metered into the polymerization mixture.

According to the invention, the weight ratio of polymer A to monomer mixture M (solid/solid) is advantageously from 10:90 to 90:10, particularly advantageously from 20:80 to 80:20 and particularly advantageously from 40:60 to 60:40.

The aqueous reaction medium can in principle also comprise small amounts of water-soluble organic solvents, such as, for example, methanol, ethanol, isopropanol, butanols, pentanols, but also acetone, etc. However, the process according to the invention is preferably carried out in the absence of such solvents.

By a specific variation of the type and amount of the monomers M1 and M2, it is possible, according to the invention, for the person skilled in the art to prepare aqueous polymer compositions whose polymers M have a glass transition temperature or a melting point in the range from −60 to 270° C. Glass transition temperature and melting point of the monomer M are to be understood in the context of this document as meaning that glass transition temperature or that melting point which the polymer obtained on polymerization of the monomer mixture M alone, i.e. polymerization in the absence of the polymer A, would have. According to the invention, the glass transition temperature of the polymer M is advantageously from ≧−20° C. to ≦105° C. and preferably from ≧20° C. to ≦100° C.

The glass transition temperature T_{g} means the limit of the glass transition temperature to which the glass transition temperature tends with increasing molecular weight, according to G. Kanig (Kolloid-Zeitschrift & Zeitschrift für Polymere, vol. 190, page 1, equation 1). The glass transition temperature or the melting point is determined by the DSC method (differential scanning calorimetry, 20 K/min, midpoint measurement, DIN 53765).

According to Fox (T. G. Fox, Bull. Am. Phys. Soc. 1956 [Ser. II] 1, page 123 and according to Ullmann's Encyclopädie der technischen Chemie, vol. 19, page 18, 4^{th} edition, Verlag Chemie, Weinheim, 1980) the following is a good approximation for the glass transition temperature of at most weakly crosslinked copolymers:

1/T_{g}=x¹/T_{g}¹+x²/T_{g}²+ . . . xⁿ/T_{g}ⁿ,

where x¹, x², . . . xₙ are the mass fractions of the monomers 1, 2, . . . n and T_{g}¹, T_{g}², . . . T_{g}ⁿ are the glass transition temperatures of the polymers composed in each case only of one of the monomers 1, 2, . . . n, in degrees kelvin. The T_{g} values for the homopolymers of most monomers are known and are mentioned, for example, in Ullmann's Encyclopedia of Industrial Chemistry, Part 5, Vol. A21, page 169, VCH Weinheim, 1992; other sources of glass transition temperatures of homopolymers are, for example, J. Brandrup, E. H. Immergut, Polymer Handbook, 1^{st} Ed., J. Wiley, New York 1966, 2^{nd} Ed. J. Wiley, New York 1975, and 3^{rd} Ed. J. Wiley, New York 1989.

The aqueous polymer compositions obtainable by the process according to the invention often comprise polymer compositions (corresponding to polymer A, polymer M and polymer A grafted with polymer M) whose minimum film formation temperature MFT is from ≧10° C. to ≦70° C., frequently from ≧20° C. to ≦60° C. or preferably from ≧25° C. to ≦50° C. Since the MFT is no longer measurable below 0° C., the lower limit of the MFT can be stated only by means of the T_{g} values. The MFT is determined according to DIN 53787.

The aqueous polymer compositions obtained according to the invention usually have polymer solids contents (sum of total amount of polymer A and total amount of monomer mixture M) of ≧10 and ≦70% by weight, frequently ≧20 and ≦65% by weight and often ≧40 and ≦60% by weight, based in each case on the aqueous polymer composition. The number average particle diameter determined by quasielastic light scattering (ISO standard 13321) (cumulant z-average) is as a rule from 10 to 2000 nm, frequently from 20 to 1000 nm and often from 50 to 700 nm or from 80 to 400 nm.

According to the invention, further optional assistants familiar to the person skilled in the art, such as, for example, so-called thickeners, antifoams, neutralizing agents, buffer substances, preservatives, free radical chain-transfer compounds and/or inorganic fillers, can also be used in the preparation of the aqueous polymer composition.

The aqueous polymer composition prepared by the abovementioned process is suitable in particular as a binder for fibrous and granular substrates. With advantage the aqueous polymer compositions can be employed as binders in the production of moldings made from fibrous and granular substrates.

Fibrous and granular substrates are familiar to the skilled worker. Examples of the fibers and granules in question include wood chips, wood fibers, textile fibers, glass fibers, mineral fibers or natural fibers such as jute, flax, hemp or sisal, but also cork chips or sand. The term “substrate” should of course also be taken to comprise the fiber webs obtainable from said fibers as well, such as needled fiber webs, as they are known, for example. With particular advantage the aqueous polymer composition according to the invention is suitable as a formaldehyde-free binder system for aforementioned natural fibers and/or fiber webs formed from them.

The process for producing a molding from a fibrous or granular substrate with an aqueous polymer composition takes place in such a way that the fibrous or granular substrate is first impregnated with an aqueous polymer composition which is obtainable by free radical initiated emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
b) from 0 to 20% by weight of at least one further ethylenically unsaturated monomer which differs from the monomers A1 [monomers A2] incorporated in the form of polymerized units,
   and the monomer mixture M being composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1,
   the impregnated fibrous or granular substrate is then brought into the desired form, and that form is subsequently dried and/or cured.

The impregnation of the fibrous and granular substrates is generally accomplished by uniformly applying the aqueous polymer composition according to the invention to the surface of said fibrous and granular substrates. The amount of aqueous polymer composition is chosen so that ≧1 g and ≦100 g, preferably ≧5 g and ≦50 g and with particular preference ≧10 g and ≦30 g of polymer composition, calculated as solid, are used per 100 g of substrate. The impregnation of the fibrous and granular substrates is familiar to the skilled worker and is accomplished for example by drenching or by spraying of the fibrous or granular substrates. Impregnation takes place advantageously using a foamed aqueous polymer composition.

Following impregnation, the fibrous or granular substrate is brought into the desired form, by being inserted into a heatable press or mold, for example, and is subsequently dried and/or cured in a manner familiar to the skilled worker.

The drying of the shape obtained is frequently carried out in two drying stages, the first drying stage taking place at a temperature ≦150° C., preferably ≧20° C. and ≦130° C. and with particular preference ≧40 and ≦100° C., and the second drying stage taking place at a temperature ≧130° C., preferably ≧150° C. and ≦250° C. and with particular preference ≧180° C. and ≦220° C.

The first drying stage advantageously takes place such that drying at a temperature ≦150° C. is carried out until the molding obtained, which frequently does not yet have its ultimate shape (and is referred to as a semi-finished product), has a residual moisture content ≦15%, preferably ≦12% and with particular preference ≦10% by weight. This residual moisture content is determined by first weighing the resulting molding at room temperature, then drying it at 130° C. for 2 minutes and subsequently cooling it and weighing it again at room temperature. The residual moisture content then corresponds to the difference in weight of the molding before and after the drying operation, relative to the weight of the molding prior to the drying operation, multiplied by a factor of 100.

The semi-finished product obtained in this way is still deformable after heating to a temperature ≧100, and at that temperature can be brought into the ultimate shape of the desired molding.

The subsequent, second drying stage takes place advantageously by heating the semi-finished product at a temperature ≧130° C. until its residual moisture content is ≦3%, preferably ≦1% and with particular preference ≦0.5% by weight, the binder frequently curing as a consequence of a chemical reaction.

In many cases the moldings are produced by converting the semi-finished product to its ultimate shape in a molding press within the aforementioned temperature ranges and carrying out curing therein.

However, it is of course also possible for the first (drying) and the second (curing) drying stages of the moldings to take place in one workstep, in a molding press, for example.

The moldings obtainable in accordance with the process of the invention feature advantageous properties, in particular an improved flexural deformation behavior and flexural stress behavior, in comparison to the moldings of the prior art.

The invention is to be explained with reference to the following nonlimiting examples.

### EXAMPLES

### A. Preparation of the Polymer A

235 g of isopropanol, 42 g of deionized water and 12.7 g of a 50% strength by weight aqueous hydrogen peroxide solution were initially taken at room temperature under a nitrogen atmosphere in a 4 I four-necked flask equipped with an anchor stirrer, reflux condenser and two metering devices. Thereafter, the initially taken solution was heated to 85° C. with stirring and, beginning at the same time, feed 1 was metered in within 6 hours and feed 2 within 8 hours, continuously with constant flow rates. Thereafter, about 400 g of an isopropanol/water mixture were distilled off, 200 g of deionized water were added and isopropanol/water was distilled off until a temperature of 100° C. was reached in the polymer solution. Thereafter, steam was passed through the aqueous polymer solution for about 1 hour while maintaining the temperature.

Feed 1 consisting of:

| | |
|---|---|
| 48.6 g | of deionized water |
| 650 g | of acrylic acid |
| 276 g | of isopropanol |

Feed 2 consisting of:

| | |
|---|---|
| 25.9 g | of a 50% strength by weight aqueous solution |
| | of hydrogen peroxide |

The aqueous polymer solution thus obtained had a solids content of 50% by weight, a pH of 1.5 and a viscosity of 118 mPa·s. The weight average molecular weight determined by gel permeation chromatography was 6600 g/mol corresponding to a K value of 25.3.

The solids content was generally determined by drying a sample of about 1 g in a through-circulation drying oven for two hours at 120° C. In each case two separate measurements were carried out. The values stated in the examples are mean values of the two measured results.

The viscosity was generally determined using a Rheomat from Physica at a shear rate of 250 s⁻¹ according to DIN 53019 at 23° C.

The pH was determined using a Handylab 1 pH meter from Schott.

The K value of the polymer A was determined according to Fikentscher (ISO 1628-1).

The determination of the weight average molecular weight of the polymer A was effected by means of gel permeation chromatography (linear column: Supremea M from PSS, eluent: 0.08 mol/l TRIS buffer pH 7.0, demineralized water, liquid flow rate: 0.8 ml/min, detector: differential refractometer ERC 7510 from ERC).

The mean particle diameter of the polymer particles was determined by dynamic light scattering on a 0.005 to 0.01 percent by weight aqueous polymer dispersion at 23° C. by means of an Autosizer IIC from Malvern Instruments, England. The mean diameter of the cumulant evaluation (cumulant z-average) of the measured autocorrelation function is stated (ISO standard 13321).

### B. Preparation of the Aqueous Polymer Compositions

### Example 1

### E1

202 g of deionized water, 750 g of the aqueous solution of polymer A and 18 g of a 50% strength by weight aqueous solution of sodium hydroxide were initially taken at room temperature under a nitrogen atmosphere in a 5 I four-necked flask equipped with an anchor stirrer, reflux condenser and two metering devices. Thereafter, the initially taken solution was heated to 90° C. with stirring and 10.7 g of feed 2 were added. After 5 minutes, beginning at the same time, feeds 1 and 3 and the residual amount of feed 2 were metered in continuously with constant flow rates within 2.5 hours.

Feed 1 consisting of:

| | |
|---|---|
| 375 g | of deionized water |
| 26.8 g | of a 28% strength by weight aqueous solution of a sodium lauryl |
| | ether sulfate (Texapon ® NSO from Cognis) |
| 22.5 g | of glycidyl methacrylate |
| 713 g | of styrene |
| 15.0 g | of acrylic acid |
| 25.0 g | of sodium pyrophosphate |

Feed 2 consisting of:

| | |
|---|---|
| 39.9 g | of deionized water |
| 3.0 g | of sodium persulfate |

Feed 3 consisting of:

| | |
|---|---|
| 75.0 g | of deionized water |
| 750 g | of the aqueous solution of polymer A |
| 18.0 g | of a 50% strength by weight aqueous |
| | solution of sodium hydroxide |

After the end of the feeds, the aqueous polymer composition was allowed to cool to 75° C. Thereafter beginning at the same time, 15.0 g of a 10% strength by weight aqueous solution of tert-butyl hydroperoxide and 18.3 g of a 13% strength by weight aqueous solution of acetone disulfite (molar reaction product of acetone with sodium hydrogen sulfite (NaHSO₃)) were added continuously with constant flow rates within 90 minutes to the aqueous polymer composition for removing residual monomers. The aqueous polymer composition E1 obtained was then cooled to room temperature. Thereafter, the aqueous polymer composition was filtered over a 125 μm net. About 0.01 g of coagulum was removed thereby.

The aqueous polymer composition E1 obtained had a pH of 3.1, a solids content of 49.9% by weight and a viscosity of 93 mPa·s. The mean particle size was determined as 204 nm.

### Example 2

### E2

108 g of deionized water, 400 g of the aqueous solution of polymer A and 9.6 g of a 50% strength by weight aqueous solution of sodium hydroxide were initially taken at room temperature under a nitrogen atmosphere in a 5 I four-necked flask equipped with an anchor stirrer, reflux condenser and two metering devices. Thereafter, the initially taken solution was heated to 90° C. with stirring and 5.7 g of feed 2 were added. After 5 minutes, beginning at the same time, feeds 1 and 3 and the residual amount of feed 2 were metered in continuously with constant flow rates within 2.5 hours.

Feed 1 consisting of:

| | |
|---|---|
| 200 g | of deionized water |
| 14.3 g | of a 28% strength by weight aqueous |
| | solution of Texapon ® NSO |
| 12.0 g | of glycidyl methacrylate |
| 208 g | of styrene |
| 172 g | of n-butyl acrylate |
| 15.0 g | of acrylic acid |
| 13.3 g | of sodium pyrophosphate |

Feed 2 consisting of:

| | |
|---|---|
| 21.3 g | of deionized water |
| 1.6 g | of sodium persulfate |

Feed 3 consisting of:

| | |
|---|---|
| 40.0 g | of deionized water |
| 1467 g | of the aqueous solution of polymer A |
| 35.2 g | of a 50% strength by weight aqueous solution of |
| | sodium hydroxide |

After the end of the feeds, the aqueous polymer composition was allowed to cool to 75° C. Thereafter beginning at the same time, 8.0 g of a 10% strength by weight aqueous solution of tert-butyl hydroperoxide and 9.7 g of a 13% strength by weight aqueous solution of acetone disulfite were added continuously with constant flow rates within 90 minutes to the aqueous polymer composition for removing residual monomers. The aqueous polymer composition E2 obtained was then cooled to room temperature. Thereafter, the aqueous polymer composition was filtered over a 125 μm net. About 0.2 g of coagulum was removed thereby.

The aqueous polymer composition E2 obtained had a pH of 3.1, a solids content of 49.5% by weight and a viscosity of 72 mPa·s. The mean particle size was determined as 230 nm.

### Comparative Example 1

### C1

500 g of the aqueous solution of polymer A were homogeneously mixed with 75 g of triethanolamine with stirring.

### Comparative Example 2

### C2

175.6 g of deionized water were initially taken at room temperature under a nitrogen atmosphere in a 2 I four-necked flask equipped with an anchor stirrer, reflux condenser and two metering devices. Thereafter, the initially taken substance was heated to 90° C. with stirring and first 63.5 g of feed 1 and then 5.7 g of feed 2 were added. After 5 minutes, beginning at the same time, the residual amounts of feeds 1 and 2 were metered in continuously with constant flow rates within 2.5 hours.

Feed 1 consisting of:

| | |
|---|---|
| 200 g | of deionized water |
| 14.3 g | of a 28% strength by weight aqueous solution of |
| | Texapon ® NSO |
| 12.0 g | of glycidyl methacrylate |
| 208 g | of styrene |
| 172 g | of n-butyl acrylate |
| 15.0 g | of acrylic acid |
| 13.3 g | of sodium pyrophosphate |

Feed 2 consisting of:

| | |
|---|---|
| 21.3 g | of deionized water |
| 1.6 g | of sodium persulfate |

After the end of the feeds, the aqueous polymer composition was allowed to cool to 75° C. Thereafter beginning at the same time, 8.0 g of a 10% strength by weight aqueous solution of tert-butyl hydroperoxide and 9.7 g of a 13% strength by weight aqueous solution of acetone disulfite were added continuously with constant flow rates within 90 minutes to the aqueous polymer composition for removing residual monomers. The aqueous polymer composition C2 obtained was then cooled to room temperature. Thereafter, the aqueous polymer composition was filtered over a 125 μm net. About 0.5 g of coagulum was removed thereby.

The aqueous polymer composition C2 obtained had a pH of 2.1, a solids content of 50.3% by weight and a viscosity of 58 mPa·s. The mean particle size was determined as 195 nm.

### C. Investigations of Performance Characteristics

Needled fiber mats measuring 30×30 cm (hemp and flax in a 1:1 weight ratio) with a basis weight of 1050 g/m² from Dittrich GmbH, Kaiserslautern, Germany were used.

The aqueous polymer compositions obtained in the inventive and comparative examples, E1 and E2 and also C1 and C2, respectively, were foamed by charging them with air using a laboratory mixer (foam density from 300 to 460 g/l). Subsequently the fiber mats were impregnated with the foamed aqueous polymer compositions using a set of rolls (pad mangle). Via the foam density and application pressure of the rolls it was possible to achieve complete impregnation of the natural-fiber mats. The amount of aqueous polymer composition (calculated as solid) was set at 263 g/m², corresponding to 25% by weight, based on the weight of the unimpregnated fiber mat.

Without further drying, the impregnated fiber mats were pressed to a thickness of 1.8 mm in a hot press at 200° C. Pressing was carried out such that the impregnated fiber mat was pressed for 15 seconds, after which the press was opened for 10 seconds for deaeration, followed by pressing for a further 45 seconds. After the mats had cooled, test specimens measuring 50×280 mm and 50×140 mm were cut in the longitudinal fiber direction. The test specimens obtained were subsequently stored in a conditioning chamber for 24 hours at 23° C. and 50% relative humidity. The fiber mats obtained as a function of the polymer composition used are referred to below as impregnated fiber mats E1, E2, C1 and C2.

### Determination of Dimensional Stability Under Heating

For this measurement, test specimens measuring 50×280 mm were stored in a climatically controlled cabinet at 80° C. and 90% relative humidity for 24 hours. Subsequently the flexural deformation of the test specimens, which were supported with supports 250 mm apart, was determined. The results are listed in table 1. The less the extent of flexural deformation, the better the evaluation of the test results.

### Determination of Flexural Stress (DIN EN ISO 14125)

The flexural stress was determined from 3-point flexural tests on test specimens measuring 50×140 mm. The distance between supports in the case of this measurement was 90 mm. A total of 4 measurements in each case were conducted on 4 test specimens. The flexural stress figures listed in table 1 represent the average values from these 4 measurements. The higher the flexural stress figures obtained, the better the evaluation of the test results.

TABLE 1
Summary of results

| | Flexural deformation | |
|---|---|---|
| | after 24 hours | Flexural stress |
| Impregnated fiber mat | [mm] | [N/mm²] |
| E1 | 17 | 48 |
| E2 | 27 | 38 |
| C1 | 60 | 21 |
| C2 | 60 | 5 |

From the results it is clearly apparent that the test specimens obtained using the aqueous polymer compositions of the invention exhibit markedly improved flexural deformation behavior and flexural stress behavior.

1: An aqueous polymer composition as a binder for fibrous or granular substrates, the aqueous polymer composition being obtainable by free radical initiated emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
from 0 to 20% by weight of at least one further ethylenically unsaturated monomer which differs from the monomers A1 [monomers A2], incorporated in the form of polymerized units,
and the monomer mixture M being composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1.

2: The binder according to claim 1, the weight ratio of polymer A to monomer mixture M being from 10:90 to 90:10.

3: The binder according to claim 1, polymer A being composed of 100% by weight of an ethylenically unsaturated monocarboxylic acid.

4: The binder according to claim 1, acrylic acid being an ethylenically unsaturated monocarboxylic acid.

5: The binder according to claim 1, the polymer A having a weight average molecular weight of ≧3000 g/mol and ≦20 000 g/mol.

6: The binder according to claim 1, the monomers M1 and M2 of the monomer mixture M being selected so that the polymer M obtained by polymerization of the monomer mixture M has a glass transition temperature of ≧−20° C. and ≦105° C.

7: The binder according to claim 1, the monomer M1 being selected from glycidyl acrylate, glycidyl methacrylate, 2-hydroxyethyl acrylate, 2-hydroxyethyl methacrylate, 3-hydroxypropyl acrylate, 3-hydroxypropyl methacrylate, 4-hydroxybutyl acrylate and/or 4-hydroxybutyl methacrylate.

8: A process for producing a molding from a fibrous or granular substrate with an aqueous polymer composition, wherein the fibrous or granular substrate is first impregnated with an aqueous polymer composition which is obtainable by free radical initiated emulsion polymerization of a monomer mixture M in an aqueous medium in the presence of a polymer A, the polymer A being composed of
a) from 80 to 100% by weight of at least one ethylenically unsaturated mono- and/or dicarboxylic acid [monomers A1] and
b) from 0 to 20% by weight of at least one further ethylenically unsaturated monomer which differs from the monomers A1 [monomers A2] incorporated in the form of polymerized units,
and the monomer mixture M being composed of
i) from 0.01 to 10% by weight of at least one ethylenically unsaturated monomer M1 which comprises at least one epoxide group and/or at least one hydroxyalkyl group, and
ii) from 90 to 99.99% by weight of at least one further ethylenically unsaturated monomer M2 which differs from the monomers M1,
the impregnated fibrous or granular substrate is then brought into the desired form, and that form is subsequently dried.

9: The process according to claim 8, wherein the monomers M1 and M2 of the monomer mixture M are selected so that the polymer M obtained by polymerization of the monomer mixture M has a glass transition temperature of ≧−20° C. and ≦105° C.

10: The process according to claim 8, wherein the amount of aqueous polymer composition is chosen so that ≧1 g and ≦100 g of polymer composition, calculated as solid, are used per 100 g of fibrous or granular substrate.

11: The process according to claim 9, wherein the drying is effected at a temperature ≧20° C. and ≦220° C.

12: A molding obtainable by a process according to claim 8.
